(19) United States
(12) Patent Application Publication
(10) Pub. No.: US 2026/0178123 A1
(43) Pub. Date: Jun. 25, 2026

(54) BIOMETRICALLY ADAPTIVE READING SYSTEM FOR ENHANCED COMPREHENSION

(71) Applicant: American Express Travel Related Services Company, Inc., New York, NY (US)

(72) Inventor: Andras L. Ferenczi, Scottsdale, AZ (US)

(21) Appl. No.: 18/987,896

(22) Filed: Dec. 19, 2024

(51) Int. Cl. G06F 3/01; G06F 40/109; G06F 40/166

(52) U.S. Cl. CPC G06F 3/015; G06F 40/109; G06F 40/166

(57) ABSTRACT

Disclosed are various embodiments for adapting content for a user based at least in part on a user preference and/or biometric data of the user. In some examples, a system comprises a client device that is configured to receive biometric data from a wearable device associated with a user identifier and determine a biometric state of a user associated with the user identifier based at least in part on the biometric data. The client device is further configured to identify a user selection of text for display on a user interface. A text adjustment for the text is generated based at least in part on providing a user preference or the biometric state to a large language model (LLM) service. A modified text in the user interface is displayed based at least in part on the text and the text adjustment.

### BACKGROUND

Users rely on a variety of different mobile devices for reading content. Some example of mobile devices can include smartphones, personal computer tablets, electronic-readers (e.g., e-readers), and other suitable types of mobile devices. The content read on these mobile devices can include literary books, academic textbooks, web content, and other types of content. The different types of content can have varying levels of complexity.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a scenario for using an adaptive reading system according to various embodiments of the present disclosure.

FIG. 2 is a drawing of a network environment according to various embodiments of the present disclosure.

FIGS. 3A and 3B are sequence diagrams illustrating examples of functionality implemented in the adaptive reading system in the network environment of FIG. 2 according to various embodiments of the present disclosure.

FIG. 4 is a flowchart illustrating one example of functionality implemented as portions of an application executed in a client device in the network environment of FIG. 2 according to various embodiments of the present disclosure.

FIG. 5 is a flowchart illustrating one example of functionality implemented as portions of an application executed in a client device in the network environment of FIG. 2 according to various embodiments of the present disclosure.

### DETAILED DESCRIPTION

The various embodiments of the present disclosure relate to an adaptive reading system for enhanced reading comprehension. The adaptive reading system can personalize a reading experience for a user by dynamically adjusting text complexity based at least in part on user preferences, biometric data for the user, and/or other suitable conditions. Mobile devices can be used for reading various types of content. Content can have different levels of complexity due to the nature of the subject matter. For example, an article in an academic journal can include a significant amount of dense thought-provoking material which can be time consuming for the reader to comprehend. In other cases, content is written for a particular audience in mind and a reader may not have the intended background for which the content was written. For instance, the reader may not have the assumed background, education, or experience on a topic. As a result, the reader may struggle with comprehending the content and may be in a confused state. In this case, the reader may reread portions of the content and/or research portions of the content that are not clear.

In other situations, the reader may be fatigued, drowsy, or lethargic. These cognitive states can also affect a reader's reading comprehension ability. In fact, readers may have a pattern throughout the day when their comprehension is at a peak and other portions of the day when their comprehension is at a low point. Understanding these patterns and cognitive user states can be used to improve the user experience and improve a user's ability to comprehend content.

Accordingly, various embodiments of the present disclosure enhance the reading comprehension ability of a reader by dynamically adapting the reading content, which can include dynamically adapting text complexity, dynamically generating drawings, and/or other suitable content adaptions. For example, the embodiments can monitor the biometric or cognitive state of a reader and dynamically adapt the text of the content based on the state of the reader. In other cases, the text of the content can be dynamically adapted based at least in part on user specified preferences. For example, the embodiments of the present disclosure can analyze a content piece and generate a readability score for the content piece. The reader may have a user preference that includes a lower readability score than the readability score for the content piece. As a result, the content can be dynamically altered in order to lower the complexity of the content piece, which can improve the reading comprehension ability of the reader. These dynamic alterations to the text (and other portions of the content item) can include adding background information at certain portions of the content, substituting words with alternative words, altering sentence structures, altering paragraph structures, generating drawings that explain the content, and other suitable alterations.

In other examples, the user interface can be configured with a feedback component in order to dynamically alter the text of the content. For instance, a reader can believe that an article is too complex and select a complexity feedback component on the user interface to lower the complexity level. In this instance, words can be substituted for alternative words and/or a figure can be generated to illustrate a concept within the text. These alternations can be dynamically generated and inserted to simplify the content and assist the reader with understanding the content.

Further, the embodiments of the present disclosure can be used to disable document features related to a user accepting, signing, initialing, or other suitable user input for binding agreements. For example, in the event the user presently has a biometric or cognitive state that is unacceptable, the embodiments can prevent the user accepting, signing, initialing, or other suitable user input for binding agreements. For instance, if the system identifies that the user has meets a fatigued state threshold, then the system will disable features for accepting, signing, or initialing a binding agreement, such as a financial agreement, a property agreement, a terms of services, a financial instrument acceptance agreement (e.g., a credit card acceptance agreement), and other suitable agreements.

Additionally, the embodiments of the present disclosure can be employed even in situations without an Internet connection. In fact, in an offline mode, the embodiments can ensure privacy and security relating the reading patterns for the user. Further, the embodiments can be employed in situations without internet connectivity, such as on an airplane, in a secure facility, a remote location without Internet, and other suitable situations without internet connectivity.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

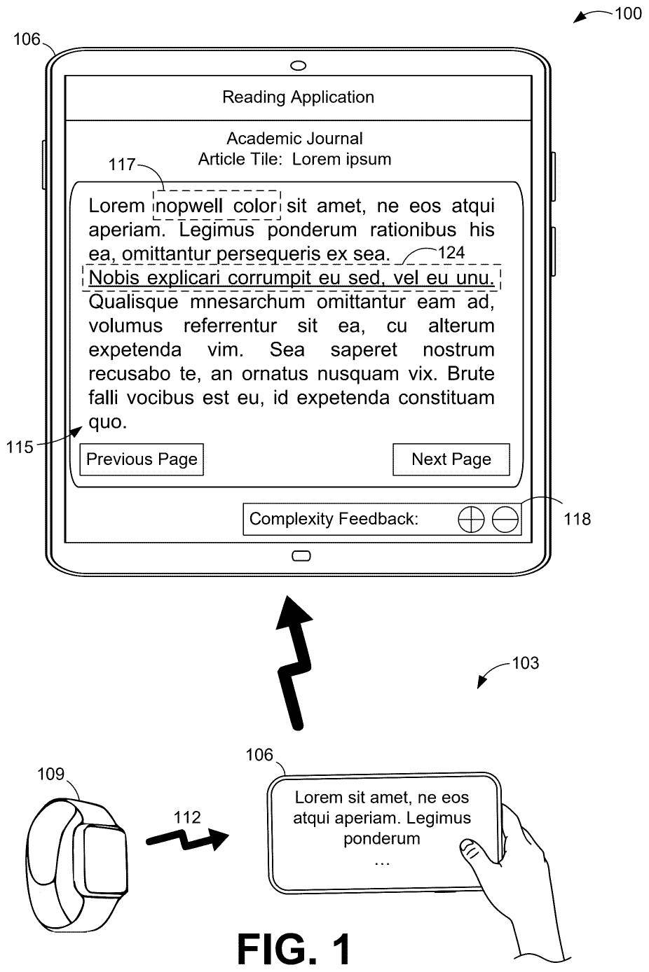

As illustrated in FIG. 1, shown is a local network environment 100 for an adaptive reading system 103. The adaptive reading system 103 includes a client device 106 and a wearable device 109, which are in data communication via a local area network 112. The local area network 112 can include a Bluetooth® network, a WIFI network, a near field communication (NFC), Zigbee, and other suitable local area networks. As such, the local area network 112 can also represent one or more personal area networks as well.

As shown in FIG. 1, the wearable device 109 is providing biometric data to the client device 106 while a user is reading content via the local area network 112. In FIG. 1, the wearable device 109 is a smartwatch that is equipped with sensors for measuring one or more physiological indicators of the user, which is transmitted as biometric data to the client device 106. For example, the biometric data can indicate that user is presently fatigued. In response, the user interface 115 has been dynamically updated to simplify the words in the original content in order to lower the complexity level. For instance, substitute words 117 have been generated and inserted in replacement of words from the original text of the content in order to make the language easier for the fatigued reader to comprehend the content.

If the user feels that the content is still too difficult to understand, the user can use the user interface 115 to further lower the complexity level of the content. For example, the user can select a complexity feedback component 118 to lower the complexity of the content. In response, the user interface 115 dynamically updates by inserting new language 124. The new language 124 can represent an explanation or a context sentence to assist a reader with portions of the content that may have a high readability or complexity score than other portions of the content. For example, a readability score can be generated for each paragraph of the content currently displayed. The paragraph with the highest readability score can be identified, in which a higher readability score represents a higher level of complexity for reading comprehension. In response, the user interface 115 can cause the explanation to be generated for the paragraph with the highest readability score.

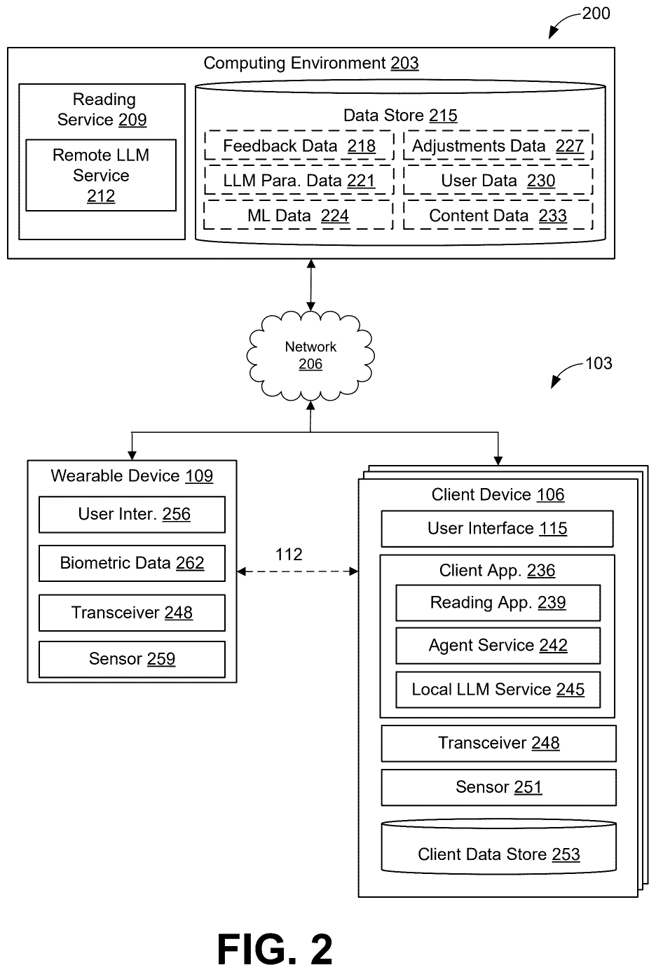

With reference to FIG. 2, shown is a network environment 200 according to various embodiments. The network environment 200 can include a computing environment 203, a client device 106, and a wearable device 109, which can be in data communication with each other via a network 206.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH®networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a reading service 209, and other applications, services, processes, systems, engines, or functionality not discussed in detail herein. The reading service 209 can be executed to provide dynamic adjustments to text content in order to improve a reader's ability to comprehend text. The reading service 209 can include a remote LLM service 212 and the remote LLM service 212 is a large language model service that generates dynamic text adjustments and provides the dynamic text to the reading service 209 and/or the client device 106.

Also, various data is stored in a data store 215 that is accessible to the computing environment 203. The data store 215 can be representative of a plurality of data stores 215, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 215 is associated with the operation of the various applications or functional entities described below. This data can include feedback data 218, LLM parameter data 221, machine learning data 224, adjustment data 227, user data 230, content data 233, and potentially other data.

The feedback data 218 can represent data associated with biometric data generated by the wearable device 109 and/or the client device 106, complexity feedback (e.g., FIG. 1 (complexity feedback component 118) from the user interface 115), user preferences, and other suitable feedback data. The biometric data can represent a biometric or cognitive state of the user, physiological indicators, and/or suitable data elements of biometric data. The complexity feedback can represent a reading complexity setting for content, which can be obtained from the selection of the complexity feedback component 118 on the user interface 115.

The LLM parameter data 221 can represent data that is aggregated and/or generated for an LLM service. After data has been aggregated, the LLM parameter data 221 can be incorporated into a LLM prompt for submission to a LLM service. Some non-limiting examples of the LLM parameter data 221 can include the content (e.g., the text or portions of the text), location reference for the text (e.g., page number, website URL), user preferences for the user identifier, the readability score for the text, and other suitable parameters.

The machine learning (ML) data 224 can represent data associated with training, validating, evaluating and deploying machine learning models, such as large language models, classification models, and other suitable models. The ML data 224 can represent the generated machine learning models (e.g., large language models, classification models), machine learning model parameters (e.g., weights, variables, etc.), and other suitable data.

In some examples, the machine learning models can use reinforcement machine learning technique to optimize the complexity of the text. For example, the complexity feedback component 118 can be used to receive adjustments of the complexity of the text. Overtime, the models can use reinforcement machine learning techniques to optimize the level of complexity of the text for the user identifier based at least in part on the selection of the complexity feedback component 118 (e.g., instances of increased complexity selection, instances of decreased complexity selected).

The adjustment data 227 can represent data associated with adjustments generated by an LLM service. The adjustments can include text adjustments, such as changes in font styles, font size change, a line spacing change, a sentence structure adjustments, word substitutions, and other suitable text adjustments. The adjustments can also include the generation of drawings to illustrate or explain the text.

The user data 230 can represent data associated with a user reading content on the client device 106. Some non-limiting examples of user data 230 can a user identifier, device identifiers for the client device 106 and the wearable device 109, user preferences for reading comprehension, and other suitable user data. The user identifier can represent a unique identifier for a user among other users associated with the client device 106 and/or the computing environment 203.

The content data 233 can represent data associated with the content that a user is reading or has a history of reading. The content can include the text associated with the content, page number data, figures/illustrations, text complexity data, and other data associated with the content.

The client device 106 is representative of a plurality of client devices that can be coupled to the network 206. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 106 or can be connected to the client device 106 through a wired or wireless connection.

The client device 106 can be configured to execute various applications such as a client application 236 or other applications. The client application 236 can be executed to dynamically adjust the reading content based at least in part on the user preferences and/or biometric data associated with the user reading the content. In some examples, the client application 236 comprises a reading application 239, an agent service 242, a local LLM service 245, and other suitable software components. The reading application 239 can represent an application for presenting content to the user, such as a book reading application, a web browser, a document viewer, and other suitable application. The agent service 242 can represent a service for interfacing with the local LLM service 245. The agent service 242 can prepare the LLM parameter data 221 for submission to the local LLM service 245. After the LLM parameters have been aggregated, the agent service 242 can generate a prompt for interfacing with the local LLM service 245. The agent service 242 can transmit the prompt and the aggregated parameters to the local LLM service 245.

The local LLM service 245 can be executed to perform natural language processing for generating dynamic adjustments to content based at least in part on the user preferences, readability scores for the content, and/or the biometric data. The local LLM service 245 can use reinforcement learning to optimize user preferences and/or content adjustments for a particular user. The local LLM service 245 can receive as input LLM parameter data 221. From the LLM parameter data 221, the local LLM service 245 can generate content adjustments in real-time or near-real-time and these adjustments can be displayed in the user interface 115 of the client device 106.

The client application 236 can also be executed in a client device 106 to access network content served up by the computing environment 203 or other servers, thereby rendering a user interface 115 on the display. To this end, the client application 236 can include a browser, a dedicated application, or other executable, and the user interface 115 can include a network page, an application screen, or other user mechanism for obtaining user input. The client device 106 can be configured to execute applications beyond the client application 236 such as email applications, social networking applications, word processors, spreadsheets, or other applications.

The client device 106 can include a transceiver 248, a sensor 251, and other suitable components. The transceiver 248 can represent one or more communication devices for interfacing on a local area network 112, a network 206, and other suitable networks. Some non-limiting examples of the data communication protocols supported can include a WiFi® protocol, a Bluetooth® protocol (e.g., Bluetooth Low Energy), near fear communication (NFC), Zigbee®, and other suitable communication protocols.

The sensor 251 can present one or more devices for detecting biometric data associated with the user. The sensors 251 for the client device 106 can include a camera, an accelerometer, a gyroscope, a microphone, and other suitable data. For example, the sensors 251 can detect eye movement of the user, movement of the client device 106 created by the user, a present orientation of the client device, sounds of the user, and other suitable data.

Also, various data is stored in a client data store 253 that is accessible to the client device 106, in which various components of the client device 106 can access data associated with the client data store 253. This data can include feedback data 218, LLM parameter data 221, machine learning data 224, adjustment data 227, user data 230, content data 233, and potentially other data. The client device store 253 can be separate and distinct from the data store 215.

The wearable device 109 can represent a device that is worn by a user reading content displayed on the client device 106. Some non-limiting examples of a wearable device 109 can include a fitness tracker, a watch, a smartwatch, smart glasses, a smart ring, and other suitable wearable devices. The wearable device 109 can include a transceiver 248, a sensor 259, and other suitable components.

The sensor 259 can represent a measurement sensor for capturing biometric data 262, such as physiological indicators, audible sounds, body movements, and other suitable data generated by the user. Some non-limiting examples of physiological indicators can include a heart rate variability (HRV), an electrodermal activity (EDA), an electrocardiogram (EKG), a blood oxygen level, and other physiological indicators. The user interface 256 can represent an interactive interface visually presented in a display component for the wearable device 109. In some embodiments, the user interface 256 and a display are omitted.

The biometric data 262 can represent a biometric or cognitive state of the user, physiological indicators, mental indicators, emotional indicators, and/or suitable data elements of biometric data. In some examples, the biometric data 262 can include a classification of the biometric data, such as fatigued stated, a confused state, an alert state, a fresh state, a stressed state, a high productivity state, a low productivity state, and other suitable classifications. The classifications can be generated by the client application 236 and/or the reading service 209.

Next, a general description of the operation of the various components of the network environment 200 is provided. To begin, a user is wearing a wearable device 109, such as a smartwatch on their wrist. The user is using a client device 106, such as a PC tablet, to read a document.

After identifying a user identifier associated with the user, the client application 236 can identify a user preference from the client data store 253. The user preference can include a preference for a level of readability (e.g., text complexity) when reading the content. The client application 236 can also identify a document that has been selected for reading. The client application 236 can submit the document and the user preference for a preferred level of readability to the local LLM service 245. The local LLM service 245 can generate a readability score for the document. Then, the local LLM service 245 can identify that the user's preferred level of readability is below the readability score for the document. For example, on a scale between 1 to 10, the user's preferred level of readability can be set to 7 and the document can be calculated to have a readability score of 9. The local LLM service 245 can use one or more readability formulas for generating the readability scores.

After a result, the local LLM service 245 can generate one or more text adjustments in order to lower the readability level of the document to be meet a readability score of 7 or lower. For example, the text adjustments can be include switching the vocabulary or terminology in the document, simplifying sentence structures, reorganizing the paragraphs, adding context language or paragraphs that provide background information, and other suitable adjustments. In some examples, the local LLM service 245 can involve iterating the text adjustments over multiple rounds. For instance, after a proposed set of text adjustments are generated, the local LLM service 245 can calculate an updated readability score for a modified version of the text and compare the updated readability score with the preferred readability score of the user.

After the text adjustments have been determined, the client application 236 can generate and display a modified version of the document based at least in part on the text adjustments. In some examples, the modified version can be generated and displayed upon a selection of a next page, a previous page, a scroll up, a scroll down, and suitable user interface content selections. As such, modified text content can be generated dynamically just as portions of the text are about to be viewed by the user.

In another example, the client device 106 can receive biometric data 262 from a wearable device 109. In some examples, the client application 236 can use a classification machine learning model to classify a present cognitive state of the user from a defined set of mental/emotional states (e.g., alert, fatigued, confused, fresh/alert, active, productive, etc.). For example, the machine learning classification model can receive a set of physiological indicators captured by the wearable device 109 and generate a classification (e.g., a confused mental state).

The client application 236 can provide the confused mental state classification and the document to the local LLM service 245. Along with these parameters, the local LLM service 245 can provide a LLM prompt with instructions for generating text adjustments for the document for a user with a confused mental state. After the text adjustments have been determined from the local LLM service 245, the client application 236 can generate and display a modified version of the document based at least in part on the text adjustments associated with the confused mental state of the user.

In another example, the client application 236 can identify a lower or higher complexity level for the content is requested based at least in part a user selection of the complexity feedback component 118 on the user interface 115. In some examples, the client application 236 can instruct the local LLM service 245 to generate a drawing or illustration and/or text adjustment. In the case of generating a drawing, the client application 236 can provide the local LLM service 245 with a specification of the available space for the requested drawing in the content. In some examples, the client application 236 can request a drawing based at least in part on the content having a readability score that is below a readability threshold score.

In some examples, the client device 106 can have a sensor 251 that can capture biometric data 262. For example, a camera for the client device 106 can capture eye and/or body movements. These movements can be captured and used to determine biometric or cognitive classifications.

In some examples, the client application 236 can identify a document type associated with the document that has been selected for reading. The client application 236 can identify the document type based at least in part on metadata associated with the document, a file name, a file format, an identifier in the document, and other suitable identifiers. The document type can be associated with one or more biometric threshold states (e.g., conditions for a biometric or cognitive state) of the user. If one or more of the biometric threshold states are met, the client application 236 can enable a document feature or disable a document feature. For example, if the client application 236 determines the present biometric state of the user is a fatigued state that meets a fatigued threshold, then the client application 236 can disable document features (e.g., user input components) for accepting, signing, initialing or other user input features for the document displayed on the client device 106. As such, the above-described functionality can be implemented for document types related to binding agreements, such as financial agreements, property agreements, purchase agreements, terms and conditions, financial instrument acceptance agreements, and other suitable agreements. In some examples, when the document features are disabled, the client application 236 can generate and display a prompt to explain the rationale for disabling the functionality.

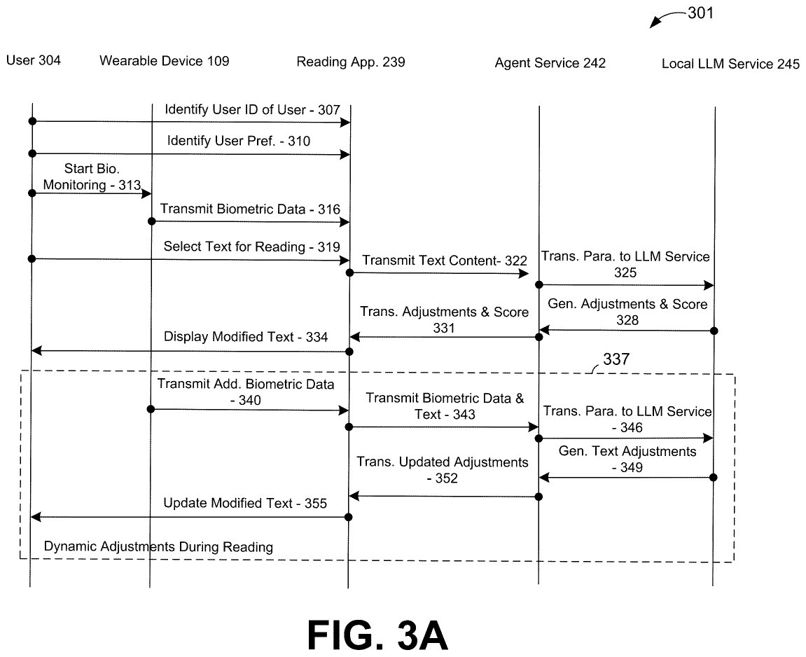

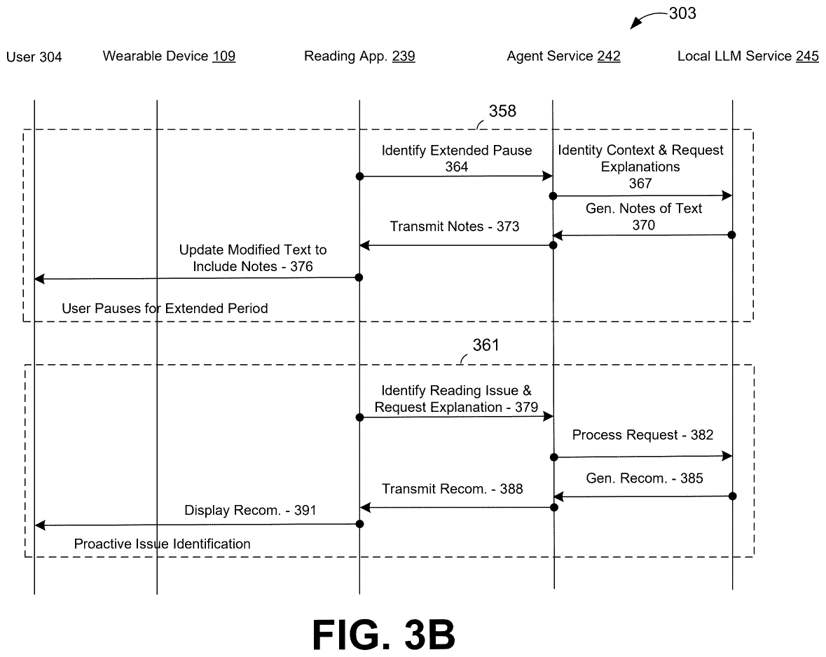

Referring next to FIGS. 3A and 3B, shown are sequence diagrams (301, 303) illustrating examples of functionality implemented in the adaptive reading system 103 in the network environment 200 of FIG. 2 according to various embodiments of the present disclosure. The sequence diagrams of FIGS. 3A and 3B provide merely an example of the many different types of functional arrangements that can be employed to implement operation of the client application 236 of the client device 106 of FIG. 2. Alternatively, the functionality depicted in FIG. 3A and FIG. 3B can be rearranged and performed by different components associated with the client application 236 of entirely by the client application 236.

Beginning in FIG. 3A, block 307 represents the reading application 239 identifying a user identifier associated with user 304. In some examples, the reading application 239 can identify the user identifier by the user providing credentials (e.g., login identifier, password, etc.), a device identifier associated with the client device 106, a browser cookie (e.g., Hypertext Transfer Protocol (HTTP) cookie) identifier, and other suitable identification methods.

In block 310, the reading application 239 can identify a user preference for the user identifier based at least in part on the user credentials, the device identifier or other suitable identifiers. The user preference can be retrieved from the user data 230 which can be stored in the client data store 253 and/or the data store 215. The user preference can represent a reading comprehension setting for the user when reading content. For example, the user preference can represent a complexity level of reading comprehension that is productive for the user. The complexity level can be based at least in part on user experience on a topic, education degrees obtained, qualifications, credentials, and other suitable factors. For example, a user can specify having obtained a doctorate degree in biology or mathematics. This education level can be used by the reading application 239 to determine a user preference for a complexity level of reading content in the areas of biology or mathematics. As such, the user is likely to be able to comprehend content at a higher level of complexity in these fields.

In other examples, the reading application 239 can generate a user preference based at least in part on recognizing patterns of reading productivity for the user. For example, the reading application 239 can determine that the user reads at a faster rate in the morning between the hours of 7:30 AM-11 AM and the user reads at a slower rate between the hours of 4 PM-6 PM. These identified patterns can be used to generate a user preference.

In block 313, the wearable device 109 can receive a command from the user to start biometric monitoring of the user. The user can initiate the command by selecting a button (e.g., via a physical button or on a user interface), an audible command, or other suitable method. The wearable device 109 can establish a data communication channel with the client device 106 via the local area network 112 or the network 206. The wearable device 109 can transmit a data stream over the local area network 112 or the network 206.

In block 316, the wearable device 109 can transmit a continuous stream of biometric data 262 to the reading application 239 of the client device 106. The wearable device 109 can capture biometric data 262 using one or more sensors 259 of the wearable device 109. For example, the sensors 259 can be used to measure heart rate variability (HRV), an electrodermal activity (EDA), a blood oxygen level, and other suitable physiological indicators. In some examples, the biometric data 262 is transmitted on a time interval, in real-time as measurements are obtained, upon demand, or according to other suitable arrangements.

In block 319, the reading application 239 can identify a selection of text content (e.g., content data 233) for reading. The user can specify a particular content item that the user desires to be loaded and displayed in the user interface 115. The reading application 239 can also identify a location reference in the selected text content (e.g., a page number, a website URL, etc.)

In block 322, the reading application 239 can transmit the text content to the agent service 242 for processing. In some examples, the reading application 239 can transmit the entire text content, such as an entire book, article, journal, website content, and other suitable portions of the content. Additionally, the reading application 239 can transmit the user identifier, a user preference, a location reference, and other suitable LLM parameter data 221.

In block 325, the agent service 242 can transmit the LLM parameter data 221 to the local LLM service 245. In some examples, the agent service 242 generates a LLM prompt for instructing the local LLM service 245 on the output request and how to process the LLM parameter data 221. In some examples, the agent service 242 can use a LLM prompt template and the LLM parameter data 221 can be inserted into one or more placeholders for the LLM prompt template. For example, the LLM prompt generated by the agent service 242 can state “Generate a text adjustment for the article ‘How to Program a Robot′ because the user has a preferred readability score of a 5 as a user preference and has no previous experience with programming a robot. The user has an undergraduate degree in electrical engineering.” The local LLM service 245 can analyze the content of the article and determine that the article was written for an electrical engineering user with at least a master degree in the field of robotics and determine the readability score of the article is a nine. Based on the user not having the suggested education background and having a lower preferred readability score, the local LLM service 245 can generate text adjustment for making the article content easier to comprehend for the user.

In block 328, the local LLM service 245 can generate text adjustments for the content. The local LLM service 245 can generate the text adjustments based at least in part on one or more components of the LLM parameter data 221, such as user preference, the context, the readability score, and other data. The readability score can indicate how difficult a passage of text is to understand. Different types of readability tests can be employed to calculate the readability score. Some non-limiting examples of readability tests can include, Flesh-Kincaid Grade Level, Flesh Reading-Ease, Gunning fox index, the SMOG Readability formula, and other suitable methods of determining a difficulty of comprehending text content. For example, the Flesh-Kincaid reading ease formula is: 206.835-1.015×(total words/total sentences)−84.6×(total syllables/total words). One of more of these reading formulas can be used to calculate readability score, which can be used to classify the difficulty level of the text, such as (e.g., elementary grade level, middle school grade level, high school grade level, college, college graduate, graduate school, professional, etc.)

The text adjustments can represent an alteration or a modification of the original context in order to improve the user's readability. For example, the user preference can indicate a preference for a particular font size, font style, color, and other suitable elements. The user preference can also represent a background level or a level of training associated of the user. For example, the user preference can indicate the user has a bachelor's degree in electrical engineering.

The readability score can be generated by the local LLM service 245 or it can be retrieved in association with the content from the content data 233 in the client data store 253 and/or the data store 215. The readability score can represent a degree of how complex or complicated the content can be for reader. In some examples, the agent service 242 can provide the local LLM service 245 with a reading scoring criteria for generating the readability score and a reference score or a scoring example. For example, the agent service 242 can include in a prompt to generate a readability score on a scale between 1 and 10 and an example article (e.g., an article titled “Emerging Robotics Developments” can have a readability score of 10).

In this example, the text adjustments can include additional text that is added to provide background information for a user with a bachelor's degree in electrical engineering and with a lower preferred readability score. The additional text can be added to help the user understand topics discussed in the content. As such, the user does not have to spend time searching other material to help explain the content currently being read.

In block 331, the agent service 242 can transmit the text adjustments and the readability score to the reading application 239. In some examples, the agent service 242 can determine context parameters for implementing the text adjustments. For example, the text adjustment can include adding an explanation paragraph on page 2 between the first and second paragraphs. In other examples, the local LLM service 245 provides the context parameters for implementing the text adjustments.

In block 334, the reading application 239 can dynamically display modified text of the content in the user interface 115. The modified text can be generated from one or more of the text adjustments, the context parameters, and the readability score. For example, the text adjustments can be inserted in line with the original text in order to generate the modified text. For example, the text adjustments can include an additional paragraph that is added inline to the original text.

In another example, the text adjustment can include substituting one or more words for another set of words that assist the user with understanding the content. The text adjustment can also include rewording sentences, altering a sentence structure, reordering sentences, and other suitable alterations.

In another example, the text adjustment can be determined based at least in part the biometric data 262. For example, before the text content is presented in the user interface 115, the agent service 242 can transmit biometric data 262 to the local LLM service 245. The biometric data 262 can indicate that the user is presently in fatigued cognitive state. The local LLM service 245 can generate text adjustments that consider the fatigued cognitive state of the user. For example, the text adjustments can include an additional content that is added to portion of the content that may be more difficult for most user to comprehend.

In another example, the reading application 239 can execute a machine learning model for classifying the biometric data 262. For example, the physiological indicators from the biometric data 262 can be submitted to a trained machine learning model to generate a cognitive classification of the user. The cognitive classification can be transmitted to the agent service 242, which can transmit the cognitive classification to the local LLM service 245.

In other examples, the content can be dynamically updated after the modified text has been presented in the user interface 115 based at least in part on additional biometric data 262 received from the wearable device 109 while the user is reading the modified text, as shown in at reference number 337. In block 340, the wearable device 109 can transmit additional biometric data 262 to the reading application 239 while the user is reading the modified text. In some examples, the reading application 239 can generate a biometric or cognitive classification by inputting the additional biometric data 262 to the machine learning model. After being generated, the reading application 239 can transmit the biometric or cognitive classification to the agent service 242. In other examples, the reading application 239 can transmit the additional biometric data 262 to the agent service 242. In these examples, the reading application 239 does not generate the biometric or cognitive classification.

In block 346, the agent service 242 can transmit the LLM parameter data 221 which can include the additional biometric data 262, the biometric or cognitive classification, the content data 233 (e.g., an entire document, an article, a website URL, the context parameters (e.g., content page number, a webpage URL, application content reference), and other suitable data. The agent service 242 can generate a LLM prompt and transmit the LLM prompt with the LLM parameter data 221.

In block 349, the local LLM service 245 can generate an updated text adjustments. For example, the additional biometric data 262 (or the biometric or cognitive classification) can reflect that the user has become fatigued after reading the content item for the past thirty minutes. As a result, the update text adjustments can include adjusting the text content in order to improve the comprehensiveness of the user in a fatigued cognitive state. For instance, the font size could be increased and/or the font style make be changed. Additionally, the text content could be broken down into additional paragraphs to order to make it easier for the user in a fatigued state to comprehend the content. As previously mentioned, the text content can be adjust by replacing words, restructuring sentences, restructuring paragraphs, and other suitable text changes. In some examples, the updated text adjustments can include a generation of drawing to illustrate the text content.

In block 352, the agent service 242 can transmit the updated text adjustments to the reading application 239. In some examples, the reading application 239 can store the text adjustments and other suitable date in the client data store 253.

In block 355, the reading application 239 can update the modified text in the user interface 115 based at least in part on the updated text adjustments that were provided from the agent service 242. In some examples, after the next page or previous page is selected, the modified text is updated before the next page or the previous page is displayed. As such, the reading application 239 can update the modified text based at least in part on a trigger condition (e.g., next page selection, a top/down selector for additional content in the user interface 115) or an extended pause in activity on a current page.

Turning now to FIG. 3B, shown is sequence diagram 303 of additional scenarios that can be identified during a reading of content. Reference number 358 refers to a first situation when the reading application 239 identifies an extended pause in reading activity. Reference number 361 refers to a second situation when the reading application 239 identifies a reading comprehension issue with the content.

In block 364, the reading application 329 identifies an extended pause in activity on the user interface 115. For instance, the reading application 329 can identify that a threshold time period has expired since a previous user interface input was received from the user. The extended pause period can represent that the user has failed to interact with the user interface 115 for an extended time period because the user is fatigued or having difficulty understanding the content. In some instances, the identified extended pause can trigger the reading application 239 to verify the biometric or cognitive state of the user based at least in part on additional biometric data 262 recently captured (or a recent biometric or cognitive classification). For instance, if the threshold time period has been expired, then the reading application 329 can determine whether recent biometric data 262 or a recent biometric/cognitive classification verifies that the user is in a fatigued state, a confused state, a stressed state, or other suitable state that where the user may need assistance. The verification can be used to eliminate other causes of the extended period with no activity.

In block 367, the agent service 242 can receive a notification of the extended pause and the agent service 242 can identify a content associated with the extended pause. For example, the agent service 242 can identify the recent biometric data 262 or biometric (e.g., cognitive) classification indicates that the user is active or alert (e.g., not fatigued). The agent service 242 can also identify other factors such as, a location reference (e.g., a page number, etc.) in the text context, a device orientation of the client device 106 (e.g., gyroscope sensor 252) to indicate how the user is holding the client device 106, etc. From the recent biometric data 262 (e.g., user is not fatigued) and other factors (e.g., client device 106 is being held in a reading orientation), the agent service 242 can determine that the user is struggling with a current location of the content.

The agent service 242 can generate a LLM prompt that request an explanation to a current location of the content. The agent service 242 can transmit the LLM prompt and the LLM parameter data 221 (e.g., the entire content document, current location in the content, user preferences, etc.) associated with the extended period state, such as the user preferences, biometric data 262, biometric/cognitive classification, and other suitable data. In some examples, the agent service 242 can indicate the specification (e.g., dimension parameters) of available space for the notes or explanation. These data elements can provide the local LLM service indications as why the user is struggling with the current location in the content.

In block 370, the local LLM service 245 can generate notes or an explanation for assisting the user at the current location of the content. The local LLM service 245 can transmit the generated notes or explanation to the agent service 242.

In block 373, the agent service 242 can transmit the notes or explanation to the reading application 239. In some examples, the reading application 239 can store the notes or explanation in the client data store 253.

In block 376, the reading application 239 can update the modified text to include the notes or explanation in the user interface 115 based at least in part on the notes or explanation provided from the agent service 242. In some examples, the notes or explanation can be added in line with the modified content. In some instances, the notes or explanations can include a visual indicator (e.g., shading around the notes/explanations, font change, font style change, a border around, etc.), to indicate that the notes or explanation are supplemental material to assist with comprehension.

In another situation, reference number 361 illustrates a second situation where the reading application 239 identifies a reading pattern issue. In block 379, the reading application 239 can identify a reading pattern issue from the user interaction data captured of the user interacting with user interface 115. For example, the reading application 239 can identify cursor movement, page selections, and other suitable user interaction data indicating that the user is not progressing through the content. Instead, the user interaction data indicates that the user is stalled. For instance, the reading application 239 can identify that the user has been viewing a particular page of the content for a significant amount of time. The reading application 239 can also identify cursor movement around a particular portion of the content or for a page of the content. Based at least in part on these factors, the reading application 239 can identify a reading issue or pattern. The reading application 239 can transmit a request for an explanation of the associated content to the agent service 242.

In block 382, the agent service 242 can generate a LLM prompt that requests a recommendation from the local LLM service 245. In some examples, the LLM prompt can generated by using a LLM prompt template for requesting a recommendation for a potential reading issue or pattern. The agent service 242 can formulate the LLM prompt by inserting the LLM parameter data 221 into one or more placeholders for the LLM prompt template. For example, the LLM prompt can state “Generate a recommendation for improving the reading comprehension of the user with a reading pattern of having to reread paragraphs four times.”

In block 385, the local LLM service 245 can generate a recommendation based at least in part the reading pattern, the LLM prompt, and other suitable LLM parameter data 221 provided to the local LLM service 245. For example, the readability score of the context and other user interactions with the content can be factored in the recommendation. The local LLM service 245 can transmit the reading recommendation to the agent service 242.

In block 388, the agent service 242 can transmit the reading recommendation to the reading application 239 for the display. For example, the reading recommendation states that the user try reading aloud certain passages that are troublesome, try identifying the main idea of the content first and then identify supporting details, identify the writing structure of the content to discover context clues for the content, and other suitable comprehension practices.

In block 391, the reading application 239 can display the reading recommendation in the user interface 115. The reading application 239 can display the reading recommendation in one or more ways in the user interface 115. For instance, the reading recommendation can be displayed as a pop-up prompt, as a banner, as a line user interface component, or other suitable display methods. Then, the process can end.

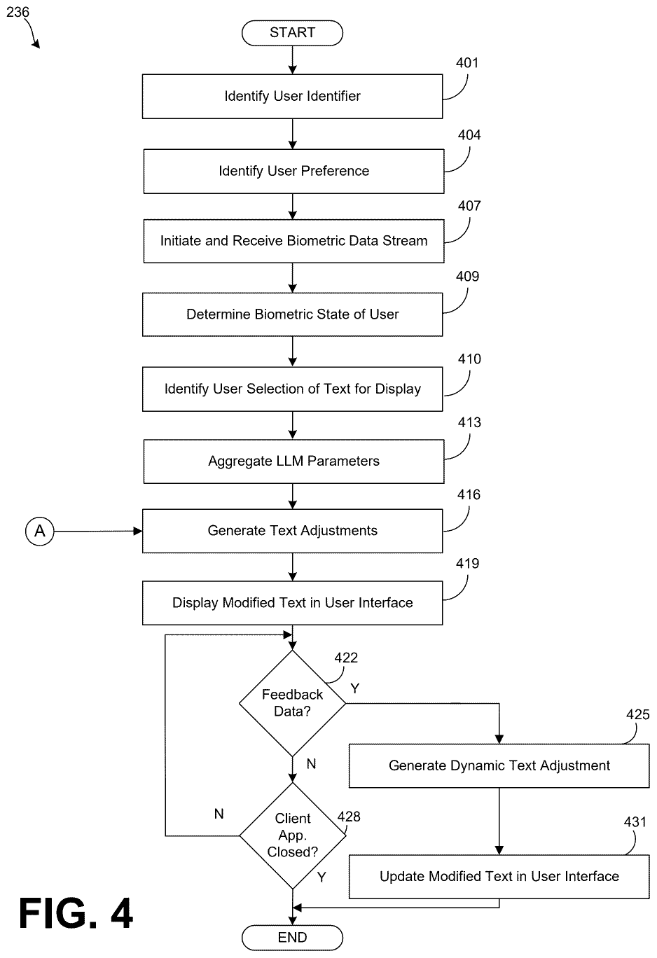

Referring next to FIG. 4, shown is a flowchart that provides one example of the operation of a portion of the client application 236. The flowchart of FIG. 4 can represent an offline mode in which the client application 236 does not access the network 206. The flowchart of FIG. 4 provides merely an example of the many different types of functional arrangements that can be employed to implement the operation of the depicted portion of the client application 236. As an alternative, the flowchart of FIG. 4 can be viewed as depicting an example of elements of a method implemented within the network environment 200 and/or the client device 106.

Beginning with block 401, the client application 236 can identify a user identifier associated with a user using the client device 106. In some examples, the client application 236 can identify the user identifier by the user providing credentials (e.g., login identifier, password, etc.). In other examples, the client application 236 can identify a user identifier based at least in part on a device identifier associated with the client device 106, a browser cookie (e.g., Hypertext Transfer Protocol (HTTP) cookie) identifier, and other suitable device identifiers. In some instances, the user preference comprises a user-specified reading comprehension setting, such as a preferred readability score or level for text complexity. In other instances, the user preference can include an education background, an experience level, a recognized reading pattern, and other suitable user preferences. In some examples, the reading application 239 of the client application 236 can be executed to identify the user identifier for the user using the client device 106.

In block 404, the client application 236 can identify a user preference for the user identifier based at least in part on the user credentials, the device identifier or other suitable identifiers. The user preference can be retrieved from the user data 230 which can be stored in the client data store 253 and/or the data store 215. The user preference can represent a reading comprehension setting for the user when reading content. For example, the user preference can represent a text complexity level of reading comprehension that is productive for the user. The complexity level can be based at least in part on user experience on a topic, education degrees obtained, qualifications, credentials, manual user selection of a level, and other suitable factors. For example, a user can specify having obtained a doctorate degree in biology or mathematics. This education level can be used by the reading application 239 to determine a user preference for a complexity level of reading content in the areas of biology or mathematics. As such, the user is likely to be able to comprehend content at a higher of complexity in these fields.

In other examples, the reading application 239 can generate a user preference based at least in part on recognizing patterns of reading productivity for the user. For example, the reading application 239 can determine that the user reads at a faster rate (e.g., assuming comprehending the material at a faster rate) in the morning between the hours of 7:30 AM-11 AM and the user reads at a slower rate between the hours of 4 PM-6 PM. These identified patterns can be used to generate a user preference. In some examples, the reading application 239 of the client application 236 can be executed to identify the user preferences for the user identifier.

In block 407, the client application 236 can initiate and/or receive a stream of biometric data 262 from the wearable device 109. In some examples, the client application 236 can transmit a command to the wearable device 109 to transmit the stream of biometric data 262 to the client application 236. The wearable device 109 can transmit data stream over the local area network 112 or the network 206. In some example, the client application 236 can determine that the network 206 (e.g., an Internet connection) is not available. In response, the client application 236 can communicate with the wearable device via local area network 112 (e.g., a personal area network, such as a Bluetooth protocol, near field communication (NFC) protocol, Zigbee protocol, a short-range propriety protocol, etc.). In some examples, the reading application 239 of the client application 236 can be executed to initiate and/or receive the stream of biometric data 262 from the wearable device 109.

In block 409, the client application 236 can determine a biometric state (e.g., a user physiological state or a user cognitive state) of the user identifier associated with the user based at least in part on the biometric data 262. In some examples, the biometric state can be determined based at least in part on one of more physiological thresholds being met by the biometric data 262 captured by the sensor 259 and/or sensor 251. Some non-limiting examples of biometric data 262 captured by can include heart rate variability (HRV), electrodermal activity (EDA), a blood oxygen level, eye movement, body movement, head tracking, and other suitable biometric data.

In other examples, client application 236 can determine the biometric state (e.g., a user cognitive state or a user physiological state) by executing a classification machine learning model based at least in part on the biometric data 262 captured by the sensor 259 and/or the sensor 251, in which the biometric data 262 is provided to the classification machine learning model. In some instance, the classification machine learning model can be trained and generated based at least in part on biometric data 262 that is unique to the user (e.g., the user identifier). Some non-limiting examples of classification machine learning models can include a Logistic regression, a Naives Bayes, a k-Nearest Neighbor, a Decision Tree, a Support Vector Machine, a Neural Network, and other suitable types of classification machine learning model techniques. The classification machine learning model can be a file trained to recognize certain types of patterns based at least in part on the training data (e.g., biometric data 262 for the user identifier and other users). The file can include weights and variables based at least in part on the identified patterns in the training data. In some examples, the reading application 239 and/or the agent service 242 of the client application 236 can be executed to determine the biometric state of the user.

In block 410, the client application 236 can receive or identify a user selection of a text (e.g., content data 233) for display. The user can specify a particular content item that the user desires to be loaded and displayed in the user interface 115. In some examples, the client application 236 can generate or retrieve a readability score for the selected text or for a portion of the text that is about to be viewed. As previously described, the client application 236 or the local LLM service 245 can generate the readability score using one or more readability formulas. In some examples, the reading application 239 of the client application 236 can be executed to identify or receive the user selection of the text for display on the client device 106.

In block 413, the client application 236 can aggregate the LLM parameter data 221 for generating a LLM prompt for the local LLM service 245. In some examples, the agent service 242 generates a LLM prompt for instructing the local LLM service 245 on the output request and how to process the LLM parameter data 221. In some examples, the client application 236 can use a LLM prompt template and the LLM parameter data 221 can be inserted into one or more placeholders for the LLM prompt template. In some examples, the agent service 242 of the client application 236 can be executed to aggregate the LLM parameter data 221 and generate the LLM prompt.

In block 416, the client application 236 can generate text adjustments and/or other content (e.g., figures, illustrations, etc.). based at least in part on providing at least one of the selected text, the user preference, or the biometric state to the local LLM service 245. The client application 236 cause the local LLM service 245 to generate text adjustments for the content and to generate a readability score for the content if not provided. The local LLM service 245 can generate the text adjustments based at least in part on one or more components of the LLM parameter data 221, such as user preferences, the context, the readability score, and other data.

The text adjustments can represent an alteration or a modification of the original context in order to improve the user's readability. Some non-limiting examples, the text adjustments can include a font size change, a line spacing change, a sentence structure adjustment, a word substitution, or other suitable adjustments. For example, the user preference can indicate a preference for a particular font size, a font style, color, and other suitable elements.

If not provided, the readability score can be generated by the local LLM service 245 or it can be retrieved in association with the content from the content data 233 in the client data store 253 and/or the data store 215. The readability score can represent a degree of how complex or complicated the content can be for a reader. In some examples, the local LLM service 245 can provide a reading scoring criteria for generating the readability score and a reference score or a scoring example. For example, the agent service 242 can include in a prompt to generate a readability score on a scale between 1 and 10 and an example article (e.g., an article titled “Emerging Robotics Developments”) can have a readability score of 10.

In some examples, the client application 236 generates the text adjustment by identifying a current page location or an adjacent page location for the text. Then, the client application 236 can generate the text adjustment for the current page location or the adjacent page location by providing the current page location or the adjacent page location and the text to the local LLM service 245. As such, the current or adjacent page location can be another parameter provided to the local LLM service 245 along with the LLM prompt. In some examples, the local LLM service 245 of the client application 236 can be executed to generate the text adjustments and/or other content (e.g., figures, illustrations, etc.).

In block 419, the client application 236 can display modified text of the content in the user interface 115 based at least in part on the text and the text adjustment. The modified text can be generated from one or more of the text adjustments, the context parameters, and the readability score. For example, the text adjustments can be inserted in line with the original text in order to generate the modified text. For example, the text adjustments can include additional paragraphs that are added in line to the original text. In some examples, the reading application 239 of the client application 236 can be executed to display the modified text and/or other content in the user interface 115.

In block 422, the client application 236 can determine whether feedback data 218 has been received after content has been displayed in the user interface 115. The feedback data 218 can include biometric data generated by the wearable device 109, user comprehension feedback (e.g., FIG. 1 (118) from the user interface 115), and other suitable feedback data 218. For example, after the display of the content, the wearable device 109 can transmit additional biometric data 262 to the client application 236. The additional biometric data 262 can represent a change in the biometric or cognitive state of the user. For instance, the user may have become fatigued during the course of reading the content. The additional biometric data 262 can include physiological indicators to reflect the user having a fatigued mental state, a stressed mental state, a confused mental state, an alert mental state, or other suitable mental states.

For example, when the user is fatigued or stressed, the user's heart rate variability (HRV) value can be lower than normal. This is because the user's sympathetic nervous system is more active, causing the user's heart to beat faster. The HRV can indicate the time difference between each heat beat. This is because the HRV detects the time difference between each beat. The autonomic nervous system is split into two parts, the sympathetic nervous system and parasympathetic nervous system. HRV changes can reflect the interaction between the sympathetic nervous system and the parasympathetic nervous system, and can be used to further assess physical fatigue status and stress.

In another example, the biometric data 262 can include electrodermal activity (EDA) captured by the sensor 259 of the wearable device 109. The EDA can be an umbrella term used for defining autonomic changes in the electrical properties of the skin of the user wearing the wearable device 109. The EDA can be a useful index of changes in sympathetic arousal that are tractable to emotional and cognitive states.

In some examples, the client application 236 can execute a classification machine learning model to generate a biometric or cognitive classification for the present state of the user. In these examples, the additional biometric data 262 can be inputted into the trained classification model. Then, the classification machine learning model can generate a classification, which can be on numeric scale (e.g., 1 to 10), a set of categories for describing the physical or mental state (e.g., active, fatigued, stressed, alert, fresh, confused, etc.), and other suitable classifications.

In other examples, the client application 236 can identify a feedback indicator from the user interface 115. For example, the user interface 115 can receive user comprehension feedback or user interface feedback (e.g., FIG. 1 (118)). For instance, the user can select the negative sign on the complexity feedback component 118 on the user interface 115 for simplifying (e.g., lower the level of text complexity) the content displayed because the user is not understanding the content. Alternatively, the positive sign on the complexity feedback component 118 can be select to increase the complexity or return the content to its original form. Regardless, the selection of the complexity feedback component 118 can provide feedback data 218 to dynamically modulate the content for reading comprehension, in which the text of the content can be adjusted.

If feedback data 218 has been received, then the client application 236 proceeds to block 425. If feedback has not been received, then the client application 236 proceeds to block 428. In some examples, the reading application 239 of the client application 236 can be executed to determine whether feedback data 218 has been received.

In block 425, the client application 236 can generate an updated adjustment and/or readability score. For example, the additional biometric data 262 (or the biometric or cognitive classification) can reflect that the user has become fatigued, confused or stressed after reading the content item for the past thirty minutes. As result, the update text adjustments can include modifications to the text content in order to improve the comprehensiveness of the user. For instance, the font size can be increased and/or the font style make be changed. Additionally, the text content can be broken down into additional paragraphs to order to make it easier for the user in their present mental state (e.g., fatigued, confused, stressed) to comprehend the content.

In some examples, the update adjustment can comprise a second text adjustment. For instance, the client application 236 can generate a second text adjustment by providing the feedback indicator and the modified text to the local LLM service 245. In some examples, the local LLM service 245 of the client application 236 can be executed to generate the updated text adjustment and/or updated readability score.

In block 428, the client application 236 can determine whether the client application 236 has been closed. If the client application 428 has been closed, then the client application 236 can proceed to the end. If the client application 428 has not been closed, then the client application 236 can proceed to the block 422. The client application 236 being closed represents that the user is done reading the content. In some examples, the reading application 239 of the client application 236 can be executed to determine whether the client application 236 has been closed.

In block 431, the client application 236 can update the modified text in the user interface 115 based at least in part on the updated text adjustments that were provided from the agent service 242. In some examples, the modified text is updated before a next page or a previous page is displayed. In other examples, the reading application 239 can update the modified text based at least in part on a trigger condition (e.g., next page selection, a top/down selector for additional content in the user interface 115) or an extended pause in activity on a current page. In some examples, the reading application 239 of the client application 236 can be executed to update the modified text in the user interface 115.

In some examples, the client application 236 can identify a document that has been selected for viewing. The client application 236 can identify a document type of the selected document and the client application 236 can identify a biometric threshold state based at least in part on the document type.

The client application 236 can receive biometric data 262 from the wearable device 109 and determine a biometric or cognitive state based at least in part on the biometric data 262. The client application 236 can determine whether the present biometric state meets the biometric threshold state. The client application 236 can disable a user interface component for user input (e.g., accepting, signing, initialing, etc.) based at least in part on the biometric or cognitive state meeting the biometric threshold state (e.g., a fatigued threshold state). The biometric or cognitive threshold state can represent a biometric classification, a biometric/cognitive rating, a biometric/cognitive score, or other suitable metrics. As such, different document types may require different biometric threshold states because of the nature of the document that is requesting user input. The client application 236 can continuously monitor the present biometric state of the user to determine when the biometric threshold states are met. In response, the user interface components can be enabled or disabled by the client application 236. In other examples, the biometric threshold state requirements can be omitted for user input features. Then, the client application 236 can proceed to the end.

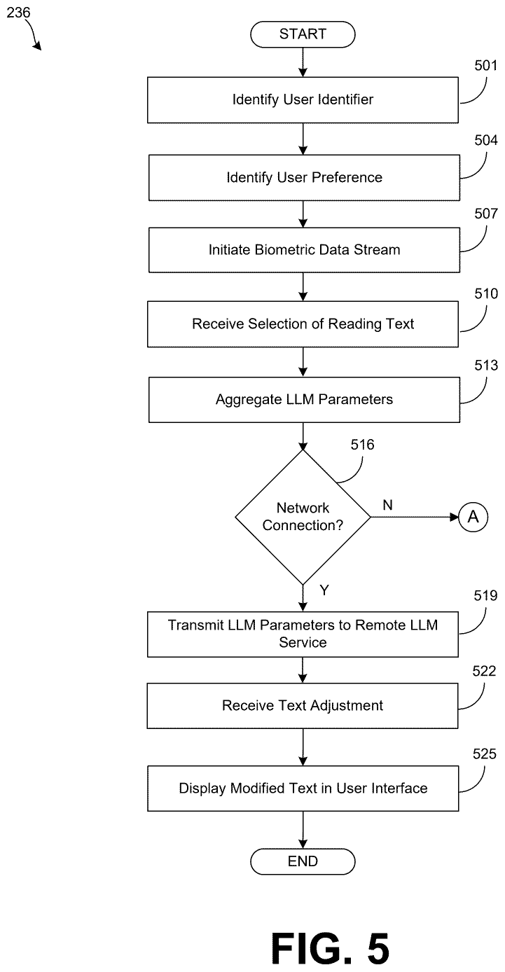

Referring next to FIG. 5, shown is a flowchart that provides one example of the operation of a portion of the client application 236. The flowchart of FIG. 5 can represent an online mode in which the client application 236 has access to the network 206. The flowchart of FIG. 5 provides merely an example of the many different types of functional arrangements that can be employed to implement the operation of the depicted portion of the client application 236. As an alternative, the flowchart of FIG. 5 can be viewed as depicting an example of elements of a method implemented within the network environment 200.

Beginning with block 501, the client application 236 can identify a user identifier associated with a user using the client device 106. In some examples, the client application 236 can identify the user identifier by the user providing credentials (e.g., login identifier, password, etc.) or a device identifier. In some examples, the reading application 239 of the client application 236 can be executed to identify the user identifier.

In block 504, the client application 236 can identify a user preference for the user identifier based at least in part on the user credentials, the device identifier or other suitable identifiers. The user preference can be retrieved from the user data 230 which can be stored in the client data store 253 and/or the data store 215. In other examples, the reading application 239 can generate a user preference based at least in part on recognizing patterns of reading productivity for the user. In some examples, the reading application 239 of the client application 236 can be executed to identify the user preferences for the user identifier.

In block 507, the client application 236 can initiate/or and receive a stream of biometric data 262 from the wearable device 109. In some examples, the client application 236 can transmit a command to the wearable device 109 to transmit the stream of biometric data 262 to the client application 236. The wearable device 109 can transmit data stream over the local area network 112 or the network 206. In some examples, the reading application 239 of the client application 236 can be executed to initiate and/or receive the stream of biometric data 262 from the wearable device 109.

Similar to FIG. 4, in some examples, the client application 236 can determine a biometric state (e.g., a user physiological state or a user cognitive state) of the user identifier associated with the user based at least in part on the biometric data 262. In some examples, the biometric state can be determined based at least in part on one of more physiological thresholds being met by the biometric data 262 captured by the sensor 259 and/or sensor 251. In some examples, the reading application 239 and/or the agent service 242 of the client application 236 can be executed to determine the biometric state of the user.

In block 510, the client application 236 can receive or identify a selection of a reading text (e.g., content data 233). The user can specify a particular content item that the user desires to be loaded and displayed in the user interface 115. In some examples, the reading application 239 of the client application 236 can be executed to identify the selection of the reading text.

In block 513, the client application 236 can aggregate the LLM parameter data 221 for generating a LLM prompt for the local LLM service 245. In some examples, the agent service 242 generates a LLM prompt for instructing the local LLM service 245 on the output request and how to process the LLM parameter data 221. In some examples, the client application 236 can use a LLM prompt template and the LLM parameter data 221 can be inserted into one or more placeholders for the LLM prompt template. In some examples, the agent service 242 of the client application 236 can be executed to aggregate the LLM parameter data 221.

In block 516, the client application 236 can determine whether the client device 106 has a connection to the network 206 for accessing the computing environment 203. If the client application 236 does not have a network connection to the computing environment 203, then the client application 236 proceeds to reference A, in which the client application 236 executes functionality described in FIG. 4 (see e.g., 416 of FIG. 4). If the client application 236 does have a network connection to the computing environment 203, then the client application 236 proceeds to block 519. In some examples, the reading application 239 of the client application 236 can be executed to determine whether the client device 106 has a connection to the network 236.

In block 519, the client application 236 can transmit the LLM parameter data 221 to the reading service 209 and/or the remote LLM service 212. In some examples, the client application 236 does not have to directly interface with the remote LLM service 212. As a result, in some examples, the client application 236 does not generate a LLM prompt for the remote LLM service 212. Instead, the client application 236 can provide the LLM parameter data 221 to the reading service 209. Alternatively, the client application 236 can generate the LLM prompts similar to the execution in FIG. 4. In some examples, the reading application 239 and/or the agent service 242 of the client application 236 can be executed to transmit the LLM parameter data 221 to the reading service 209 and/or the remote LLM service 212.

In block 522, the client application 236 can receive the text adjustments from the remote LLM service 212. The text adjustments can represent an alteration or a modification of the original context in order to improve the user's readability. For example, the user preference can indicate a preference for a particular font size, font style, color, and other suitable elements. The user preference can also represent a background level, a readability level, a level of training associated of the user, or other suitable reading comprehension setting. In some examples, the reading application 239 and/or the agent service 242 of the client application 236 can be executed to receive the text adjustments.

In block 525, the client application 236 can display modified text of the content in the user interface 115. The modified text can be generated from one or more of the text adjustments, the context parameters, and the readability score. For example, the text adjustments can be inserted in line with the original text in order to generate the modified text. For example, the text adjustments can include an additional paragraph that is added in line to the original text. Then, the client application 236 proceeds to the end. In some examples, the reading application 239 of the client application 236 can be executed to display modified text of the content.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The the sequence and flowchart diagrams of FIGS. 3A, 3B, 4 and 5 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence and flowchart diagrams of FIGS. 3A, 3B, 4 and 5 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence and flowchart diagrams of FIGS. 3A, 3B, 4 and 5 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a client device comprising a processor and a memory; and
machine-readable instructions stored in the memory that, when executed by the processor, cause the client device to at least:
identify a user preference associated with a user identifier of a wearable device;
receive biometric data from the wearable device associated with the user identifier;
determine a biometric state of a user associated with the user identifier based at least in part on the biometric data;
identify a user selection of text for display on a user interface;
generate a text adjustment for the text based at least in part on providing the text and the user preference or the biometric state to a large language model (LLM) service; and
display modified text in the user interface based at least in part on the text and the text adjustment.

2. The system of claim 1, wherein the text adjustment comprises at least one of a font size change, a line spacing change, a sentence structure adjustment, or a word substitution.

3. The system of claim 1, wherein the biometric data representing a physiological indicator that comprises at least one of a heart rate variability (HRV) indicator, an electrodermal activity (EDA) indicator, or a blood oxygen level.

4. The system of claim 1, wherein the biometric state is a user cognitive state and the determination of the user cognitive state further causes the client device to at least:
determine the user cognitive state by executing a classification machine learning model, the classification machine learning model being provided the biometric data, the user cognitive state representing a user ability level for reading comprehension.

5. The system of claim 1, wherein the user preference representing a user-specified reading comprehension setting.

6. The system of claim 1, wherein the generation of the text adjustment further cause the client device to at least:
identify a current page or an adjacent page for the text; and
generate the text adjustment for the current page or the adjacent page by providing the current page or the adjacent page and the text to the large language model service.

7. The system of claim 1, wherein the text adjustment is a first text adjustment, and the machine-readable instructions further cause the client device to at least:
identify a feedback indicator from the user interface;
generate a second text adjustment by providing the feedback indicator and the first text adjustment to the LLM service; and
update the modified text in the user interface based at least in part on the second text adjustment generated by the LLM service.

8. A method, comprising:
receiving, by a client device, biometric data from a wearable device associated with a user identifier;
determining, by the client device, a biometric state for the user based at least in part on the biometric data;
identifying, by the client device, a user selection of text for display on a user interface;
generating, by the client device, a text adjustment for the text based at least in part on providing the text and the biometric state to a large language model (LLM) service; and
displaying, by the client device, modified text in the user interface based at least in part on the text and the text adjustment.

9. The method of claim 8, wherein the text adjustment comprises at least one of a font size change, a line spacing change, a sentence structure adjustment, or a word substitution.

10. The method of claim 8, wherein the biometric data representing a physiological indicator that comprises at least one of a heart rate variability (HRV) indicator, an electrodermal activity (EDA) indicator, or a blood oxygen level.

11. The method of claim 8,, wherein the biometric state is a user cognitive state and determining the user cognitive state further comprises:
determining the user cognitive state by executing a classification machine learning model, the classification machine learning model being provided the biometric data, the user cognitive state represent a user ability level for reading comprehension.

12. The method of claim 8, wherein generating the text adjustment for the text further comprises:
identifying a user preference associated with the user identifier, the user preference representing a reading comprehension setting, the LLM service generating the text adjustment based at least in part on the user preference.

13. The method of claim 8, wherein generating the text adjustment further comprises:
identifying a current page or an adjacent page for the text; and
generating the text adjustment for the current page or the adjacent page by providing the current page or the adjacent page and the text to the large language model service.

14. The method of claim 8, wherein the text adjustment is a first text adjustment, and the method further comprises:
identifying, by the client device, a feedback indicator from the user interface;
generating, by the client device, a second text adjustment by providing the feedback indicator and the first text adjustment to the LLM service; and
updating, by the client device, the modified text in the user interface based at least in part on the second text adjustment generated by the LLM service.

15. A non-transitory, computer-readable medium, comprising machine-readable instructions that, when executed by a processor of a client device, cause the client device to at least:
receive biometric data from a wearable device associated with a user identifier;
determine a biometric state of a user associated with the user identifier based at least in part on the biometric data;
identify a user selection of text for display on a user interface;
generate a text adjustment for the text based at least in part on providing the text and the biometric state to a large language model (LLM) service; and
display modified text in the user interface based at least in part on the text and the text adjustment.

16. The non-transitory, computer-readable medium of claim 15, wherein the text adjustment comprises at least one of a font size change, a line spacing change, a sentence structure adjustment, or a word substitution.

17. The non-transitory, computer-readable medium of claim 15, wherein the biometric data representing a physiological indicator that comprises at least one of a heart rate variability (HRV) indicator, an electrodermal activity (EDA) indicator, or a blood oxygen level.

18. The non-transitory, computer-readable medium of claim 15, wherein the biometric state is a user cognitive state and determining the user cognitive state further causes the client device to at least:
determine the user cognitive state by executing a classification machine learning model, the classification machine learning model being provided the biometric data, the user cognitive state represent a user ability level for reading comprehension.

19. The non-transitory, computer-readable medium of claim 15, wherein generating the text adjustment for the text further causes the client device to at least:
identify a user preference associated with the user identifier, the user preference representing a reading comprehension setting, the LLM service generating the text adjustment based at least in part on the user preference.

20. The non-transitory, computer-readable medium of claim 15, wherein generating the text adjustment further cause the client device to at least:
identify a current page or an adjacent page for the text; and
generate the text adjustment for the current page or the adjacent page by providing the current page or the adjacent page and the text to the large language model service.
